(19) United States
(12) Patent Application Publication
(10) Pub. No.: US 2008/0315825 A1
(43) Pub. Date: Dec. 25, 2008

(54) Self-Sustained Current Supply Device For Mobile Small Appliances

(76) Inventor: Oliver Lang, Berlin (DE)

Correspondence Address: Law Offices of Karl Hormann, P O Box 381516, Cambridge, MA, 02238-1516, US

(21) Appl. No.: 11/658,974

(22) PCT Filed: Jul. 27, 2005
(86) PCT No.: PCT/DE05/01345

§ 371 Date: Jan. 29, 2007

(30) Foreign Application Priority Data
Jul. 28, 2004 (DE) 10 2004 037 329.9

(51) Int. Cl. H02J 7/00

(52) U.S. Cl. 320/101

(57) ABSTRACT

A self-sustained current supply device based on a modular concept with an energy-autarkic generator module being connected with appliance-specific exchangeable battery/electronics modules wherein an additional battery matching the small appliance can be charged within a short time.

### BACKGROUND OF THE INVENTION

1. Field of the Invention

The invention relates to a compact self-sustained power supply unit for the operation of mobile small appliances independently of a current net, with at least one net-independent generator, control electronics and a receptacle for rechargeable batteries.

2. The Prior Art

For operating mobile small appliances, especially mobile telephones and organizers (PDA) the supply of power constitutes an increasing problem in view of the fact that while on the one hand the control circuits used in the appliances are becoming more energy efficient, yet on the other hand the complexity and functionality of the appliances are increasing with increased energy consumption compared to earlier generations of appliances. At the same time, the mobility of their users has increased significantly as has the need constantly to use various accompanying electric appliances even in remote areas or in transportation means without access to power nets.

Owing to this tendency, numerous developments and inventions have come about which provide for further energy sources based upon primary batteries, fuel cells or solar cells for extending the operability of small appliances. Overall, the proposed and realized developments in the actual state of the art may be grouped as follows:
A) External energy supply devices with chargeable intermediate storage and corresponding control electronics: Here, the energy generated by an external energy source, for instance a solar generator, is initially stored and is subsequently or simultaneously transmitted to the small appliance. The small appliance itself is, however, not structurally changed at all. The disadvantage in this connection is the high loss of energy as a result of the intermediate storage and the intermediate storage as an expensive additional component. Examples of such apparatus are German patent application DE 199 28 809 A1 or the solar charging apparatus iSun of the Canadian company ICP Global.
B) External energy storage devices with primary intermediate storage: In contrast to A), instead of the generator-intermediate storage combination, a primary energy storage is used, for instance a high-capacitive Li or Zn air battery is used which following the charging of the small appliance must be disposed and replaced by a new battery. In this connection, the drawback resides in the undesirable use of single-use components given the world-wide scarcity of resources and environmental pollution. Examples: Products of the US-Israeli company Electric Fuel.
C) Devices similar to A), yet without intermediate storage or, where present, as a replacement of the energy storage in the small appliance. Such devices are usually mounted directly on the small appliance and transmit the energy generated by means of contact devices. They suffer from the disadvantages of difficult handling, the undesirable exposure of the small appliance to the sun and attendant heat development in the case of a solar generator and their structural limitation to a single small appliance. A further disadvantage is the fact that in the case of a solar generator the small appliance cannot be used as desired during the extended charging operation since it has to be placed into sun light. German patent application DE 198 26 923 A1 offers an example of this kind.
D) Devices similar to C) but provided as an integrated component of the small appliance and, therefore, requiring structural changes as well as incorporation into the existing charging and energy management system of the small appliance. Except for its operation, it entails the same disadvantages as C.). Examples are the Nokia Cell Phone Type 1611 (market introduction about 1998). Developments by Fraunhofer Institut ISE as regards divers cell phones and PDA's during 1998-2000 or by the Motorola company of cell phones with fuel cells. Examples from the patent literature are British application DB 2,379,131 A1 or International Application WO 0,165,711.

A further category of current supply devices does not strictly speaking belong to the previous listing since the term “self-sufficient” does not apply to them. But it constitutes, nevertheless, one of the bases for the present invention, viz.: current net charging devices for auxiliary rechargeable batteries, especially as assorted accessories of some mobile telephones. Aside from their dependency on net current, the disadvantage of these devices is, like in the case of D.), the structural limitation to one type of cell phone or its rechargeable battery.

All of the devices referred to above thus suffer from at least one of the following problems, particularly when used in connection with solar generators:
in actual use they cannot, be easily manipulated (complex contacting (e.g. after removal of the original battery of the appliance), complex unfolding of a solar generator, exposure of the small appliance to sun light, thus continuous use not possible, etc.);
Charging operation subject to loss and, therefore, in the case of an external intermediate storage, of extended duration which can only be shortened by excessively sized components;
charge current too low because of too small a solar cell surface where integrated in modern mobile appliances, as well as damage to the battery in consequence of heat generation;
structural limitation to a particular small appliance or rechargeable battery.

### OBJECT OF THE INVENTION

Supplying the small appliance by a current supply device is to be accomplished in a practical and easily operable form, within a reasonable interval of time and without structural change of the small appliance. Above all, it is to be possible to charge different small appliances by the same device. This constitutes the object of the instant invention, with the closed prior art being devices of category A.) Referred to above.

### SUMMARY OF THE INVENTION

In accordance with the invention the object is accomplished by the structure of a modular unit of a base generator module and a device-specific rechargeable battery/electronics module electrically connected thereto in a removable manner by a contact device and provided with adapted control electronics and battery charge cradle for at least one additional battery of the small appliance. In this connection, as to charge cradle and control electronics the battery/electronics module is adapted to a particular type of small appliance and can be exchanged by simple manual action for a module suited for another type of small appliance. The rechargeable battery of the small appliance is to be fully charged within a few hours (e.g. in case of a solar generator at full solar radiation) and may then easily be placed by user into the small appliance to replace the discharged battery. For recharging, the discharged battery is then placed into the charge cradle while the small appliance may be utilized as desired. In this connection, the structural design of the control electronics is important relative to the unchanging solar generator on the one hand and the various types of battery in respect of their charge voltage, charge current and charge algorithm. Because of the integration of the electronics into a charge module with unchanging charge cradle it would in normal circumstances not be possible to place and thereby possibly damaging a battery not designed for this module in view of the fact that in terms of structural shape and contact position small appliance batteries are usually distinct from each other. Compared to charging by way of the charge electronics integrated in a small appliance, the principle of charging an additional battery offers the advantage of a significantly more effective charge in view of the fact that almost all small appliances do not use a low-power circuit design of the charge management and thus waste a lot of the stand-by current when being charged.

A useful further improvement of the invention resides in the provision of the battery/electronics module with a charge connection for the current net charging device of the small appliance. This makes charging of the battery possible without recourse to a generator, such as a solar generator, in bad weather. The actual battery charge module is comparable to the charge devices for additional batteries of cell phones as described in the prior art.

Furthermore, instead of battery/electronics modules for batteries specific to small appliances, battery/electronics modules for commercial standard batteries, e.g. NiMH/NiCd or RAM cells of aa (Mignon) or AAA (Micro) sizes are conceivable as well. The control electronics must, similar to small appliance batteries, be adapted to the requirements of the given standard batteries. Commercial universal net devices may be used as current net devices for such modules which may be connected, for instance, by an common electric plug provided within the module.

Ideally, the control electronics is provided with circuitry for adjusting to the voltage level between the operating point (MPP) of the solar generator and the required charging voltage of the battery. This may be accomplished, for instance, by a highly efficient DC/DC converter. In addition, the circuit should be able to generate the charge parameters or charge algorithms prescribed for the given battery type, such as, for instance, the current and voltage limitations of Li-ion batteries, temperature readings with a corresponding current and voltage control, switching off of residual charge balances, etc. Also, a connection for an external current net should be taken into consideration. The use of a freely programmable microprocessor with appropriate peripheral components (e.g. integrated in a micro controller micro-chip) would be advantageous in this connection. It would allow the circuit electronics to be designed identically in all battery/electronics units and only the processor software would have to be appropriately adjusted. LED's or a LCD display may be used for controlling the charge and for monitoring the state of the charge. Also, a connection by way of a PC interface, e.g. by way of a USB, would be feasible for obtaining an external energy supply on the one hand, and for exchanging data with the PC relating to the charge management.

An advantageous improvement of the invention resides in structuring the generator module as an erectable solar generator unit made up of at least one solar module which for charging is placed into sunlight in an unfolded state and which for transporting is flatly folded down. In such an arrangement, the battery/electronics module is disposed at the rear surface of the solar generator module to provide for shading the battery from the sun. Advantageously, the battery/electronics module may be connected to the solar generator module by metallic pivoting pins and may by such an arrangement also be hung up and picked up. The described arrangement should be structured in a robust and UV-resistant manner in order to ensure safe operation even at frequent use. This is particularly important in respect of the solar generator since because of its modular connection it may be used for many years even in connection with subsequent small appliances provided with novel battery/electronics modules. Highly efficient solar cells with efficiency factors above 15% (e.g. mono and polycrystalline silicon) are used for the solar generators in order to provide for as compact a structure as possible.

Of course, because of the modularity of the system the use of further solar generator modules of different efficiency data and dimensions is possible as well. More particularly, different kinds of generators, such as wind, crank or fuel cell powered generators, may be used which are mechanically and electrically compatible with the system.

In a further embodiment the current supply device may be provided with an electronic step-up transformer which in the circuit is arranged behind the battery and which transforms the voltage of the battery to a higher voltage which is fed to the small appliance by way of a contact and an external charge cable. While this again makes use of the indirect charge principle in accordance with category A) including the disadvantages described above, certain users may prefer operation by way of a simple cable connection over the somewhat more cumbersome exchanging of the battery. At any rate, one would be able to chose between the two methods. If the mentioned additional device is fed over the same connection as the one provided for the external current net component, it will be necessary to provide a switch for switching between charging of the internal battery by way of the connector and a discharge into the small appliance by way of an external cable.

### DESCRIPTION OF THE SEVERAL DRAWINGS

The novel features which are deemed to be characteristic of the invention are set forth with particularity in the appended claims. The invention itself, however, in respect of its structure, construction, lay-out and design, as well as manufacturing techniques and technology, together with other objects and advantages thereof will be best understood from the following description of the preferred embodiments when read with reference to the appended drawings, in which:

FIG. 1 is a side view of the housing of the device with a solar modulator module in its unfolded state;

FIG. 2 is a rear view of the housing of the device with a solar generator;

FIG. 3 is a view of the housing of the device with a solar generator in its folded-down state; and

FIG. 4 is a circuit block diagram of the electrical components.

### DETAILED DESCRIPTION OF THE PREFERRED EMBODIMENT

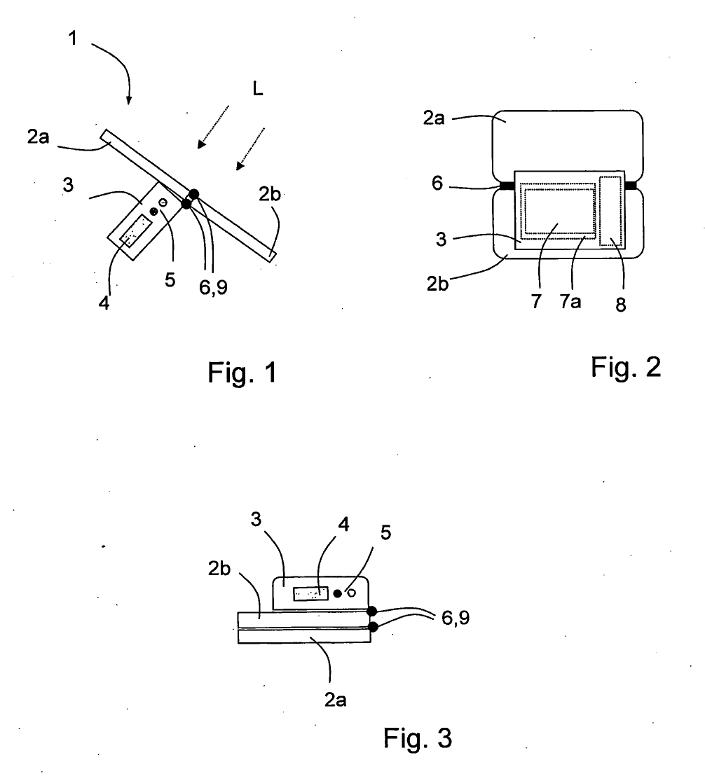

FIG. 1 is a side elevational view depicting the basic structure of a self-sustained current supply device 1 in accordance with the invention. The embodiments shows two solar generators 2a, 2b in their unfolded state which constitute the generator module and which are mechanically and electrically connected to each other by hinges 6 with integrated contact devices 9, e.g. hinge pins as well as to the battery/electronics module 3. The connector 4 for net current as well as two LED's 5 for indicating full charge and charge current may be seen at the side. In the embodiment shown, the current supply device 1 is set up such that sunlight exactly irradiates both solar modules 2a, 2b.

FIG. 2 is a rear view of the current supply device 1 of FIG. 1, the position of the electronic component 8 and of the battery compartment 7a with inserted battery 7 within the battery/electronics module 3 being shown in dotted lines.

FIG. 3 again depicts the current supply device 1 in the same lateral view as FIG. 1, yet in its folded-down state. As can be seen, the two solar modules 2a, 2b are folded with their light sensitive surfaces facing each other in order to protect them from scratches during transport.

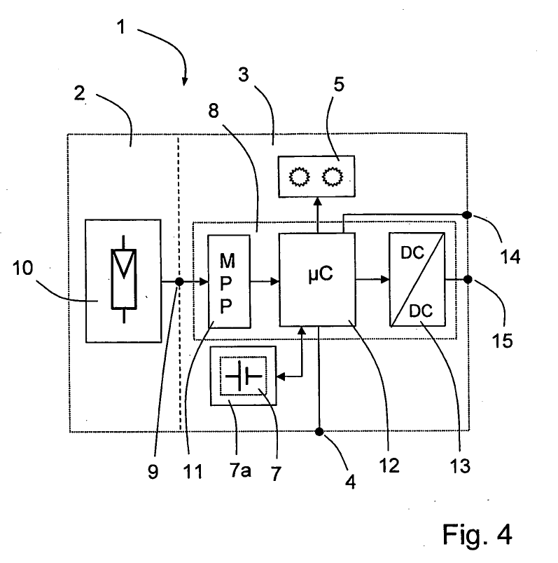

FIG. 4 depicts the block circuit diagram of the current supply device 1 with all previously described components. The generator module 2 contains a net autarkic generator 10, e.g. a solar module, a fuel cell or a crank generator. In accordance with FIGS. 1-3, several generators may be present which would be connected in parallel to each other and, by way of the contact device 9, with the battery/electronics module. If necessary, the battery/electronics module initially provides, by the shown circuit component 11, for conformity between the generator MPP and the charge voltage of the battery. Downstream from the circuit component 11 there is the analog/digital control component 12 including micro processor and appropriate peripherals for regulating the input and output currents from the external charge input 4 into and out of the battery 7 within the battery compartment 7a, as well as, optionally, the DC/DC converter 13, and for transmitting digital signals to the LED or LCD indicator and to and from the PC interface 14. The connector 15 serves to charge the small appliance through an external cable with the DC/DC converter 13 providing the required higher charge voltage.

1-10. (canceled)

11. An apparatus for recharging batteries of a mobile small appliance, comprising:
a net autarkic generator module;
at least one battery/electronics module comprising a battery and an electronic component;
means for removable mounting and electrically connecting the battery/electronics module to the generator module; and
electronic means and battery charging cradles provided on the battery/electronics module adapted to mate with different small appliances.

11. The apparatus of claim 1, wherein the battery/electronics module is provided with a charge connection adapted to match the standard net charge device of the small appliance.

12. The apparatus of claim 1, wherein the battery/electronics module is structured as a universal battery/electronics module for charging commercial batteries.

13. The apparatus of claim 1, wherein the electronic component comprises a voltage converter for high-efficiency transmission of power from the ideal generator operating point to the actual charge voltage.

14. The apparatus of claim 13, wherein the electronic component further comprises means for regulating the charging of the battery in accordance with prescribed parameters thereof.

15. The apparatus of claim 14, wherein the electronic component further comprises means for controlling the charge current by way of the charge connection.

16. The apparatus of claim 1, wherein the electronic component further comprises a freely programmable micro processor and peripherals.

17. The apparatus of claim 1, further comprising means for indicating at least one of the charge operation, the charge condition and other functions.

18. The apparatus of claim 17, wherein the means for indicating comprises at least one of a LED and LCD.

19. The apparatus of claim 1, wherein the generator module comprises at least two solar modules connected to each other and to the battery/electronics module for pivotal movement between a closed state for protecting the solar modules and an open state for exposing the solar modules and protecting the battery/electronics module form exposure to sun light.

20. The apparatus of claim 1, wherein the generator module comprises at least one of a fuel cell and a wind and crank operated generator.

21. The apparatus of claim 1, further comprising means for connecting to the interface of a PC for the bidirectional transmission of at least one of power and data.

22. The apparatus of claim 1, further comprising a step-up transformer for charging the small appliance from the battery of the battery/electronics module.
